(19) United States
(12) Patent Application Publication
(10) Pub. No.: US 2010/0079706 A1
(43) Pub. Date: Apr. 1, 2010

(54) POLARIZER, METHOD OF MANUFACTURING THE SAME, DISPLAY SUBSTRATE HAVING THE POLARIZER, AND BACKLIGHT ASSEMBLY HAVING THE POLARIZER

(75) Inventors: Dong-Hoon KIM, Suwon-si, (KR); Dong-Yeol YEOM, Asan-si, (KR); Joong-Hyun KIM, Suwon-si, (KR); Seung-Mo KIM, Cheonan-si, (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si, (KR)

(21) Appl. No.: 12/552,497

(22) Filed: Sep. 2, 2009

(30) Foreign Application Priority Data
Sep. 29, 2008 (KR) 2008-0095134

(51) Int. Cl. G02F 1/1335; G02B 5/30; G02B 1/08; F21V 9/14; B05D 5/06

(52) U.S. Cl. 349/96; 359/486; 427/163.1; 362/19

(57) ABSTRACT

A polarizer includes a first base layer, a reflective polarizing layer and a protective layer. The reflective polarizing layer includes a plurality of a wire-grid polarizer (“WGP”) pattern disposed on the first base layer and spaced apart from each other at substantially uniform intervals. The protective layer contacts the reflective polarizing layer to define an air layer between the WGP patterns, the first base layer and the protective layer.

This application claims priority to Korean Patent Application No. 2008-95134, filed on Sep. 29, 2008, and all the benefits accruing therefrom under 35 U.S.C. §119, the contents of which are herein incorporated by reference in their entirety.

### BACKGROUND OF THE INVENTION

1. Field of the Invention

The present invention relates to a polarizer, a method of manufacturing the polarizer, a display substrate including the polarizer and a backlight assembly including the polarizer. More particularly, the present invention relates to a polarizer having reflection and polarization functions, a method of manufacturing the polarizer, a display substrate including the polarizer and a backlight assembly including the polarizer.

2. Description of the Related Art

A liquid crystal display (“LCD”) device includes an LCD panel and a backlight assembly. The LCD panel displays images using light transmittance of liquid crystal. The backlight assembly is disposed under the LCD panel, opposing a viewing side of the LCD panel, to provide the LCD panel with light. A liquid crystal layer of the LCD panel is used as a light shutter to display the images, such that light irradiated to the LCD panel should be linearly polarized.

In order to change randomly polarized light generated from the backlight assembly into linearly polarized light, the LCD panel further includes a polarizing plate. The polarizing plate absorbs a relatively large amount of the light generated from the backlight assembly of the LCD device so that the optical efficiency of the light generated from the backlight assembly of the LCD device is greatly reduced. Accordingly, research is being conducted to improve these problems.

Alternatively, an optical sheet such as a dual brightness enhancement film (“DBEF”), such as manufactured by 3M Company, has been used to improve optical characteristics of light generated from a light source in a backlight assembly. When randomly polarized light is incident into the DBEF, about 85% of first polarized light of one direction is transmitted, and about 90% of second polarized light having another direction crossing the first polarized light is reflected.

### BRIEF SUMMARY OF THE INVENTION

When an optical sheet, such as a dual brightness enhancement film (“DBEF”) is used to improve optical characteristics of light generated from a light source in a backlight assembly, there may be disadvantages in the performance of the LCD panel and in a manufacturing process. For example, light that exits from the DBEF may not completely linearly polarized so that the polarizing plate disposed in the LCD panel may still be required. Additionally, even though optical efficiency is increased by the DBEF, the polarizing plate absorbs about 20% to about 25% of the light that exits from the DBEF, which reduces the potential optical efficiency. Furthermore, when the optical sheet such as the DBEF is used, manufacturing costs may be greatly increased.

Alternative technology to the DBEF has been employed, such as including wire-grid polarizer (“WGP”) patterns. However, there may be disadvantages in the operation and/or the manufacturing of a LCD device. For example, the WGP pattern may be formed by a photomask process. When the photomask process is performed, precise WGP patterns are not formed, and the manufacturing costs may be greatly increased so that productivity may be decreased. Furthermore, the ability to produce larger LCD devices may be limited.

Exemplary embodiments of the present invention provide a polarizer capable of having a large size and improving optical efficiency.

Exemplary embodiments of the present invention also provide a method of manufacturing the above-mentioned polarizer.

Exemplary embodiments of the present invention also provide a display substrate including the above-mentioned polarizer.

Exemplary embodiments of the present invention provide a backlight assembly including the above-mentioned polarizer. An exemplary embodiment of a polarizer includes a first base layer, a reflective polarizing layer and a protective layer. The reflective polarizing layer is disposed on the first base layer and includes a plurality of a wire-grid polarizer (“WGP”) pattern spaced apart from each other at substantially uniform intervals. The protective layer is disposed on the reflective polarizing layer, and the protective layer contacts the reflective polarizing layer to form an air layer between the WGP patterns.

In an exemplary embodiment of the present invention, the reflective polarizing layer may further include a metal layer disposed on the WGP patterns.

In an exemplary embodiment of the present invention, the protective layer may include an optical pattern condensing and diffusing light transmitted through the reflective polarizing layer.

In an exemplary embodiment of the present invention, the polarizer is disposed on the protective layer, and the polarizer may further include a second base layer having a thickness substantially identical to the thickness of the first base layer.

In an exemplary embodiment of the present invention, the polarizer is disposed on the second base layer, and the polarizer may further include an optical pattern condensing and diffusing light transmitted through the second base layer.

An exemplary embodiment provides a method of manufacturing a polarizer. In the method, the reflective polarizing layer is formed including a plurality of a WGP pattern disposed on the first base layer and spaced apart at uniform intervals. A protective layer is formed on the reflective polarizing layer, and the protective layer contacts the reflective polarizing layer to form an air layer between the WGP patterns.

In an exemplary embodiment of the present invention, forming the reflective polarizing layer may include forming a coating layer on the first base layer. The WGP pattern may be formed by pressing the coating layer using a mold in which a pattern, corresponding to the WGP patterns, has been formed. The coating layer including the pattern formed thereon may be cured, and the mold may be removed from the coating layer.

An exemplary embodiment of a display substrate includes a base substrate, a pixel layer and a polarizing part. The pixel layer is disposed on the base substrate, and includes a plurality of a pixel unit. The polarizing part is disposed below the base substrate, and the polarizing part includes a polarizing part and a protective layer. The reflective polarizing layer includes a plurality of a WGP pattern spaced apart at uniform intervals. The protective layer is disposed on the reflective polarizing layer, and contacts the reflective polarizing layer to form an air layer between the WGP patterns.

An exemplary embodiment of a backlight assembly includes a light source and a reflective polarizer. The light source generates the light. The reflective polarizer is adjacent to the light source. The reflective polarizer includes a reflective polarizing layer and a protective layer. The reflective polarizing layer is disposed on the first base layer, and the reflective polarizing layer includes a plurality of a WGP pattern spaced apart at uniform intervals. The protective layer contacts the reflective polarizing layer patterns to form an air layer between the WGP patterns.

According to exemplary embodiments of a polarizer, a method of manufacturing the polarizer, a display substrate including the polarizer and a backlight assembly including the polarizer, a protective layer is formed on a reflective polarizing layer having reflection and polarization functions. Advantageously, inflow of particles and reduction of optical efficiency may be reduced or effectively prevented. Moreover, an air layer is formed between WGP patterns when the protective layer is formed, so that optical efficiency may be advantageously enhanced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is perspective view illustrating an exemplary embodiment of a polarizer, according to Embodiment 1 of the present invention;

FIGS. 2A to 2F are cross-sectional views illustrating an exemplary embodiment of a method of manufacturing the polarizer in FIG. 1;

FIG. 3 is a cross-sectional view illustrating an exemplary embodiment of a polarizer according to Embodiment 2 of the present invention;

FIG. 4 is a cross-sectional view illustrating an exemplary embodiment of a polarizer according to Embodiment 3 of the present invention;

FIG. 5 is a cross-sectional view illustrating an exemplary embodiment of a polarizer according to Embodiment 4 of the present invention;

FIG. 6 is a cross-sectional view illustrating an exemplary embodiment of a liquid crystal display (“LCD”) panel including a polarizer according to the present invention; and

FIG. 7 is an exploded perspective view illustrating an exemplary embodiment of an LCD device including a backlight assembly including a polarizer according to the present invention.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of preferred exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

FIG. 1 is perspective view illustrating an exemplary embodiment of a polarizer 101 according to Embodiment 1 of the present invention.

Referring to FIG. 1, the polarizer 101 may include a base layer 110, a reflective polarizing layer 120 and a protective layer 130. The polarizer 101 may be substantially planar member, which may hereinafter be referred to as a sheet or plate.

The base layer 110 may include a material having a relatively high transmissivity, heat resistance and/or chemical resistance. In an exemplary embodiment, the base layer 110 may include, but is not limited to, glass, polyethylene naphthalate, polyethylene terephthalate or polyacryl.

The reflective polarizing layer 120 is disposed on the base layer 110. The reflective polarizing layer 120 may be disposed directly on an upper surface of the base layer 110. In an exemplary embodiment, the reflective polarizing layer 120 may include a plurality of a wire-grid polarizer (WGP) pattern 122.

Each of the WGP patterns 122 has a predetermined width and thickness, and is extended along a first direction D1. Each of the WGP patterns 122 may extend a whole of a dimension of the base layer 110 in the first direction D1, such that the each of the WGP patterns 122 overlaps a whole of a portion of the base layer 110 in the first direction D1.

The WGP patterns 122 are arranged and spaced apart from each other at substantially uniform intervals along a second direction D2 crossing the first direction D1. The first direction D1 may be substantially perpendicular to the second direction D2. The arrangement of the WGP patterns 122 may be hereinafter referred to as having a stripe type or profile. The WGP patterns 122 may be formed of a material having high transmissivity and low light absorbance. In one exemplary embodiment, the WGP patterns 122 may include acrylic resin.

In an exemplary embodiment, the reflective polarizing layer 120 may further include a metal layer 124.

Referring to FIG. 1, the metal layer 124 is disposed on the WGP patterns 122. A plurality of the metal layer 124 may be disposed directly on an entire of an upper surface of each of a WGP pattern 122. Each of the plurality of the metal layer 124 may be referred to as being aligned, or corresponding with, a respective one of the plurality of the WGP pattern 122. The metal layer 124 may be disposed between the WGP pattern 122 and the protective layer 130. In an exemplary embodiment, the metal layer 124 may include a metal having a relatively high reflectivity, such as aluminum (Al), silver (Ag), copper (Cu), gold (Au) and/or molybdenum (Mo).

The reflective polarizing layer 120 both reflects and polarizes light entering through the base layer 110, and incident on the reflective polarizing layer 120 from the base layer 110. Light having an electric field vector parallel to an extended direction D1 of the WGP patterns 122 is defined as s-polarized light. Light having an electric field vector perpendicular to an extended direction D1 of the WGP patterns 122 is defined as p-polarized light. The reflective polarizing layer 120 reflects the s-polarized light, and polarizes the p-polarized light. Accordingly, the light transmitted through the reflective polarizing layer 120 is substantially the p-polarized light.

The polarizing properties and the transmissivity of the reflective polarizing layer 120 depend on a pitch P defined by a width W of the WGP patterns 122, a thickness T of the WGP patterns 122 and a distance between the WGP patterns 122. As shown in FIG. 1, the width W and the pitch P are taken substantially parallel to the second direction D2. The thickness T is taken in a third direction substantially perpendicular to the upper surface of the base layer 110. The first direction D1, the second direction D2 and the third direction may be defined as orthogonal to each other.

It is preferred the pitch P be smaller than a wavelength of light incident on the WGP patterns 122, so that the WGP patterns 122 may have polarizing properties. In one exemplary embodiment, when an incident light is visible light, the wavelength of the visible light is about 400 nanometers (nm) to 700 about nanometers (nm), and the pitch P may be smaller than or equal to about 400 nm, so that the WGP patterns 122 may have polarizing properties. In a further preferred embodiment, the pitch P of the WGP patterns 122 is no more than about 100 nm, such that the reflective polarizing layer 120 has excellent polarizing properties. The width W of the WGP patterns 122 may be no more than about 100 nm.

The thickness T of the WGP patterns 122 may be about 150 nm to about 250 nm to improve polarized transmissivity. The polarized transmissivity is defined as the ratio of an amount of the light transmitted with respect to an amount of the light incident into the reflective polarizing layer 120. The higher the polarized transmissivity, the better the optical efficiency of the LCD panel.

The protective layer 130 is disposed on the reflective polarizing layer 120 to protect the reflective polarizing layer 120. The protective layer 130 may reduce or effectively prevent corrosion of the metal layer 124 and foreign particles from accumulating between the WGP patterns 122.

As illustrated in FIG. 1, the protective layer 130 is disposed directly on and contacting an upper surface of the metal layer 124. Alternatively, the protective layer 130 is disposed directly on and contacting the WGP patterns 122. The protective layer 130 is disposed spaced apart from a bottom surface of a space between the WGP patterns 122, and be spaced apart from the upper surface of the base layer 110.

An air layer 140 may be disposed between the WGP patterns 122 and defined by the protective layer 130. A portion of the upper surface of the base layer 110, a portion of a lower surface of the protective layer 130, and inner surfaces of the WGP patterns 122 and the metal layer 124 define the space between the WGP patterns 122.

The plurality of the WGP patterns 122 may include a first portion and a second portion, each protruding from the upper surface of the base layer 110. The first portion of the WGP patterns 122 may have a thickness in the third direction larger than a thickness of the second portion. The first and second portions of the WGP patterns 122 may be alternated with each other across the upper surface of the base layer 110, in the second direction D2. The second portion of the WGP patterns 122 may be disposed in a space defined by the portion of the upper surface of the base layer 110, a portion of a lower surface of the protective layer 130, a portion of the inner surfaces of the first portions of the WGP patterns 122, and inner surfaces of the metal layer 124. Here, the space between the WGP patterns 122 is defined by an upper surface of second portion of the WGP patterns 122, a portion of a lower surface of the protective layer 130, and inner surfaces of the WGP patterns 122 and the metal layer 124.

The first and second portions of the WGP patterns 122 form a continuous and indivisible WGP pattern layer member. The plurality of the WGP pattern 122, including the first and second portions, overlaps an entire of the upper surface of the base layer 110.

In exemplary embodiments, the protective layer 130 may include a material having a relatively high transmissivity. The protective layer 130 may include heat-curable materials or ultraviolet (“UV”)-curable materials. In one exemplary embodiment, the protective layer 130 may include acrylic resin, epoxy resin, etc. A thickness of the protective layer 130, taken in the third direction, may range from approximately a few hundred nm, to approximately tens of thousands of nm. In one exemplary embodiment, the thickness of the protective layer 130 may be about 100 nm to about 10,000 nm.

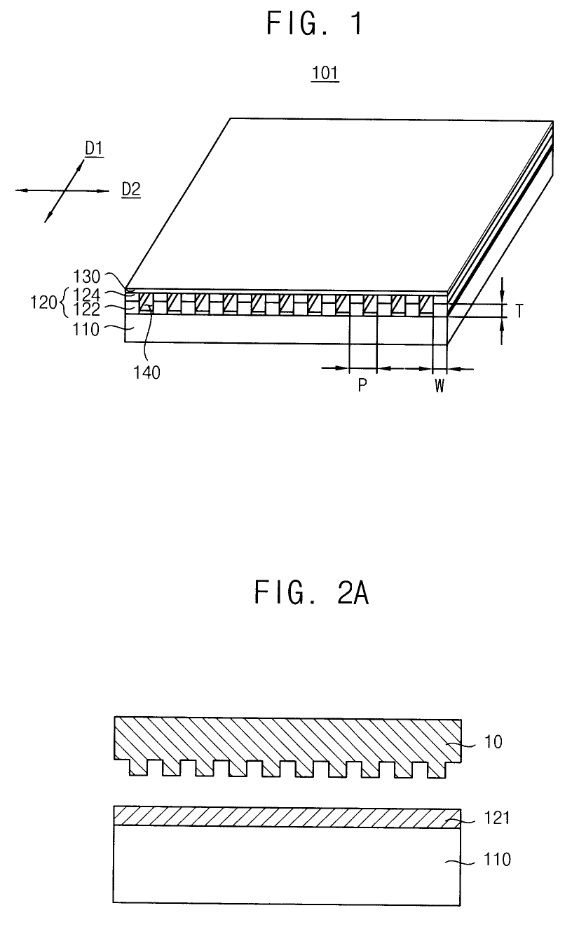

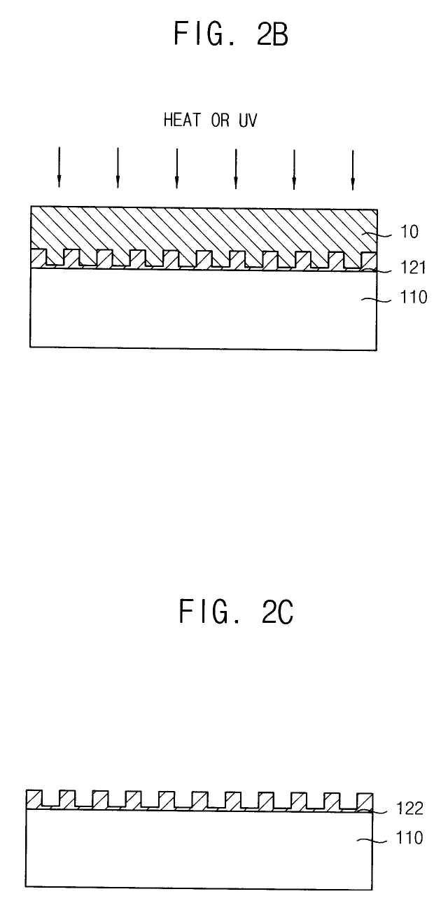

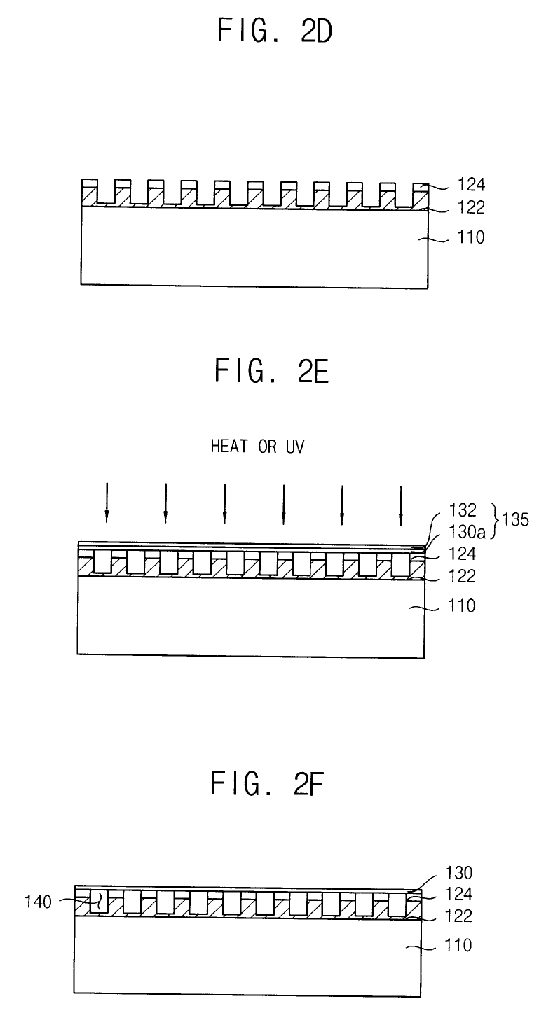

FIGS. 2A to 2F are cross-sectional views illustrating an exemplary embodiment of a method of manufacturing the polarizer in FIG. 1.

Referring to FIG. 1 and FIG. 2A, a coating layer 121 is formed on a first surface of the base layer 10. In one exemplary embodiment, the coating layer 1 may be formed by a wet coating process. The coating layer 1 may include organic materials. In one exemplary embodiment, the coating layer 121 may be formed of acrylic resin. In addition, the coating layer 121 may be a material which is cured by heat or UV light.

Referring to FIG. 2B, a mold 10 including a predetermined pattern contacts the coating layer 121, and pressure is applied. In one exemplary embodiment, the mold 10 applies a pressure to the coating layer, by using a roller (not shown) transferring pressure to the mold 10. The mold 10 may include optically transparent materials, such as polymethylmethacrylate (“PMMA”).

The coating layer 121 is cured by heat or UV light, as indicated by the downward arrows in FIG. 2B. The mold 10 is separated from the coating layer 121. The plurality of the WGP pattern 122 is formed on the base layer 110 in FIG. 2C. The WGP patterns 122 form a continuous and indivisible WGP pattern layer member on the base layer 110. The plurality of the WGP pattern 122 overlaps an entire of the upper surface of the base layer 110.

Referring to FIG. 2D, the metal layer 124 is formed on the WGP patterns 122. In one exemplary embodiment, the metal layer 124 may be formed by a sputtering process or an electron-beam (e-beam) evaporation process. The metal layer 124 may include a metal having a relatively high reflectivity such as aluminum (Al), silver (Ag), copper (Cu), gold (Au) and/or molybdenum (Mo).

The protective layer 130 is formed on the metal layer 124. In one exemplary embodiment, the protective layer 130 may be formed using a transfer film 135 illustrated in FIG. 2E. The transfer film 135 may include a transfer layer 130a. The transfer layer 130a is transferred to the metal layer 124 to form the protective layer 130. The transfer film 135 may include a protective film 132 formed on the transfer layer 130a to reduce or effectively prevent contamination of the transfer layer 130a. The transfer layer 130a may include a material having adhesiveness.

Referring to FIG. 2E, the transfer film 135 is disposed on the metal layer 124. A heat or UV light is irradiated onto the transfer film 135 so that the transfer layer 130a reacts to the heat or the light to have adhesiveness between the transfer layer 130a and the metal layer 124. The protective film 132 is removed.

The protective layer 130 is formed on the metal layer 124 in FIG. 2F. The protective layer 130 may reduce or effectively prevent corrosion of the metal layer 124, and foreign particles from accumulating between the WGP patterns 122. An air layer 140 is formed between the WGP patterns 122, in a space defined by the protective layer 130, the metal layer 124, the WGP patterns 122 and the base layer 110. The forming of the protective layer 130 creates a difference of refractive index according to the air layer 140.

Advantageously, the WGP patterns 122 may be relatively easily formed by using the mold 10 having the predetermined pattern of the WGP patterns 122 profile, to improve productivity during a manufacturing process. In addition, optical efficiency may be increased by a difference of refractive index according to the air layer 140 formed between the WGP patterns 122 when the protective layer 130 is formed.

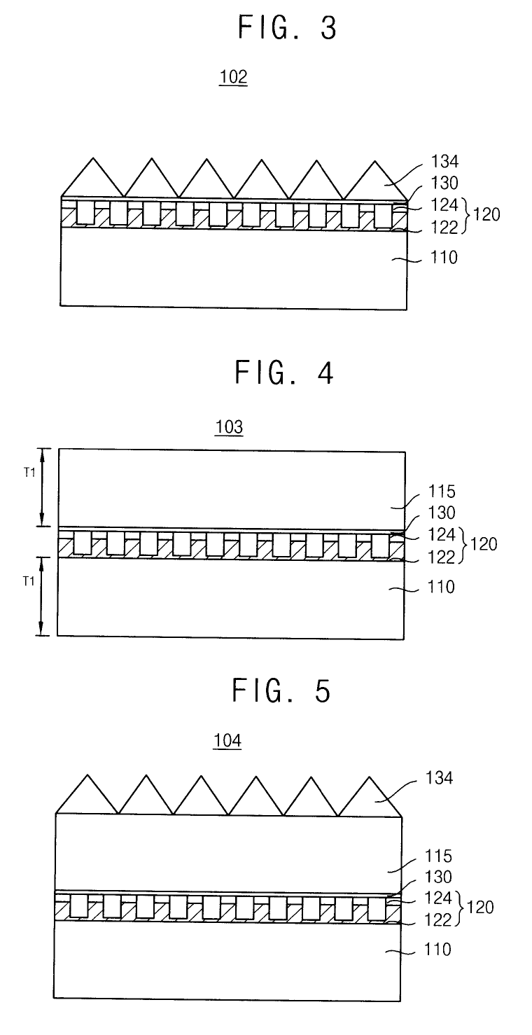

FIG. 3 is a cross-sectional view illustrating an exemplary embodiment of a polarizer 102 according to Embodiment 2 of the present invention.

A polarizer 102 according to the illustrated embodiment is substantially identical to the polarizer 101 of Embodiment 1 described with reference to FIG. 1, except that the protective layer 130 includes an optical pattern 134. Thus, elements substantially identical to those of the polarizer of Embodiment 1 will be used to refer to the same reference numerals as those described with reference to FIG. 1, and a detailed explanation will be omitted to avoid redundancy.

A method of manufacturing a polarizer 102 is substantially identical to the method of manufacturing the polarizer 101 of Embodiment 1 described with reference to FIGS. 2A to 2F, except that the protective layer 130 includes an optical pattern 134. Thus, a detailed explanation will be omitted to avoid redundancy.

Referring to FIG. 3, the polarizer 102 may include the base layer 110, the reflective polarizing layer 120 and the protective layer 130.

The reflective polarizing layer 120 may include the WGP patterns 122 and the metal layer 124.

As illustrated in FIG. 3, the protective layer 130 is disposed directly on and contacting an upper surface of the metal layer 124. The protective layer 130 may reduce or effectively prevent corrosion of the metal layer 124 and inflow of particles. In an exemplary embodiment, the protective layer 130 contacts the WGP patterns 122. The protective layer 130 is disposed spaced apart from a bottom surface of a space between the WGP patterns 122. The air layer 140 is formed between the WGP patterns 122 by the protective layer 130. The protective layer 130 may include a material having a relatively high transmissivity. The protective layer 130 may include heat-curable materials or UV-curable materials. In one exemplary embodiment, the protective layer 130 may include acrylic resin, epoxy resin, etc.

The protective layer 130 may include a plurality of an optical pattern 134. The plurality of the optical pattern 134 may overlap an entire of an upper surface of the protective layer 130, as illustrated in FIG. 3.

The plurality of the optical pattern 134 condenses and diffuses the light transmitted through the reflective polarizing layer 120, an incident on the protective layer 130 including the optical patterns 134. The optical patterns 134 may be formed integrally with the protective layer 130, such that the protective layer 130 and the optical patterns 134 form a single, continuous and indivisible protective layer member.

In an exemplary embodiment, the protective layer 130 may be formed by using a transfer film, in substantially a same method as described for Embodiment 1. The transfer layer including the optical pattern 134, is transferred to the metal layer 124 to form the protective layer 130 including the optical patterns 134. The protective layer 130 is formed on the reflective polarizing layer 120 by a transfer process.

Each of the plurality of the optical pattern 134 is disposed directly on and contacting the upper surface of the protective layer 130. Each optical patterns 134 is disposed extended in a direction substantially parallel to the extended direction of the WGP patterns 122. In an exemplary embodiment, the optical patterns 134 may not include a gap between the optical patterns 134, as illustrated in FIG. 3. The optical patterns 134 may be disposed directly adjacent to and consecutive each other in an arrangement direction substantially perpendicular to the extending direction, such that edges of the optical patterns 134 contact each other in a plane view.

A cross-section of the optical pattern 134 may have a prism shape, as shown in FIG. 3. In alternative embodiments, the optical pattern 134 may be modified into various shapes, such as a lenticular shape, a microlens array, etc. (not shown).

According to the illustrated embodiment in FIG. 3, the polarizer 102 not only condenses and diffuses the light transmitted, but also has a polarizing function. Advantageously, when the polarizer 102 is applied to a display device, a sheet such as a diffusion sheet or a condensing sheet, may be omitted.

FIG. 4 is a cross-sectional view illustrating an exemplary embodiment of a polarizer according to Embodiment 3 of the present invention.

A polarizer 103 according to the illustrated embodiment is substantially identical to the polarizer 101 of Embodiment 1 described with reference to FIG. 1, except that an upper base layer is formed on the protective layer 130. Thus, elements substantially identical to those of the polarizer of Embodiment 1 will be used to refer to the same reference numerals as those described with reference to FIG. 1, and a detailed explanation will be omitted to avoid redundancy.

A method of manufacturing a polarizer 103 is substantially identical to the method of manufacturing the polarizer 101 of Embodiment 1 described with reference to FIGS. 2A to 2F, except that the upper base layer is formed on the protective layer 130. Thus, a detailed explanation will be omitted to avoid redundancy.

Referring to FIG. 4, the polarizer 103 may include a lower base layer 110, the reflective polarizing layer 120, the protective layer 130 and an upper base layer 115.

The upper base layer 115 is disposed directly on and contacting an upper surface of the protective layer 130. The upper base layer 115 is disposed overlapping and contacting an entire of the upper surface of the protective layer 130. The upper base layer 115 may include a material substantially the same or identical to the lower base layer 110. The upper base layer 115 may include a material having a relatively high transmissivity, heat resistance and chemical resistance. In one exemplary embodiment, the upper base layer 115 may include, but is not limited to, glass, polyethylene naphthalate, polyethylene terephthalate or polyacryl.

As illustrated in FIG. 4, the upper base layer 115 may have a thickness T1 substantially identical to a thickness T1 of the lower base layer 110, the thicknesses taken in the third direction.

According to the illustrated embodiment, the lower base layer 110 is disposed below the reflective polarizing layer 120, and the upper base layer 115 is disposed on the reflective polarizing layer 120 so that the lower base layer 110 and the upper base layer 115 have substantially the same thickness, to reduce or effectively prevent a bimetal effect. The lower base layer 110 is disposed opposing the upper base layer 115 with respect to the protective layer 130, the metal layer 124 and/or the WGP patterns 122.

FIG. 5 is a cross-sectional view illustrating an exemplary embodiment of a polarizer according to Embodiment 4 of the present invention.

A polarizer 104 according to the illustrated embodiment is substantially identical to the polarizer 101 of Embodiment 1 described with reference to FIG. 1, except that the upper base layer 115 and the optical pattern 134 are both formed on the protective layer 130. Thus, elements substantially identical to those of the polarizer of the Embodiment 1 will be used to refer to the same reference numerals as those described with reference to FIG. 1, and a detailed explanation will be omitted to avoid redundancy.

A method of manufacturing a polarizer 104 is substantially identical to the method of manufacturing the polarizer 101 of Embodiment 1 described with reference to FIGS. 2A to 2F, except that the upper base layer 115 and the optical pattern 134 are both formed on the protective layer 130. Thus, a detailed explanation will be omitted to avoid redundancy.

Referring to FIG. 5, the polarizer 104 may include the lower base layer 110, the reflective polarizing layer 120, the protective layer 130, the upper base layer 115 and the optical pattern 134. The upper base layer 115 is disposed between the optical pattern 134, and each of the protective layer 130, the metal layer 124, the and the WGP patterns 122.

The upper base layer 115 is disposed directly on and contacting an upper surface of the protective layer 130. The upper base layer 115 may include a material substantially the same or identical to the lower base layer 110. The upper base layer 115 may include a material having a relatively high transmissivity, heat resistance and/or chemical resistance. In one exemplary embodiment, the upper base layer 115 may include, but is not limited to, glass, polyethylene naphthalate, polyethylene terephthalate or polyacryl.

As illustrated in FIG. 5, the upper base layer 115 may have a thickness T1 substantially identical to a thickness T1 of the lower base layer 110, the thicknesses taken in the third direction.

The optical pattern 134 is disposed directly on and contacting an upper surface of the upper base layer 115. The optical pattern 134 condenses and diffuses the light transmitted through the upper base layer 115, which is incident on an incident side of the optical pattern 134. The optical pattern 134 is disposed extended in a direction substantially parallel to the extended direction of the WGP patterns 122, and the optical patterns 134 may not include a gap between the optical patterns 134 in an arrangement direction substantially perpendicular to the extended direction.

A cross-section of the optical pattern 134 may have a prism shape, as shown in FIG. 5. In alternative embodiments, the optical pattern 134 may be modified into various shapes, such as, a lenticular shape, a microlens array, etc. (not shown).

According to the illustrated embodiment, the lower base layer 110 is disposed below the reflective polarizing layer 120, and the upper base layer 115 is disposed on the reflective polarizing layer 120 opposite to the lower base layer 110, so that the lower base layer 110 and the upper base layer 115 have substantially a same thickness to reduce or effectively prevent a bimetal effect.

According to the illustrated embodiment, the polarizer 104 including the optical pattern 134, not only condenses and diffuses the light transmitted, but also advantageously has a polarizing function.

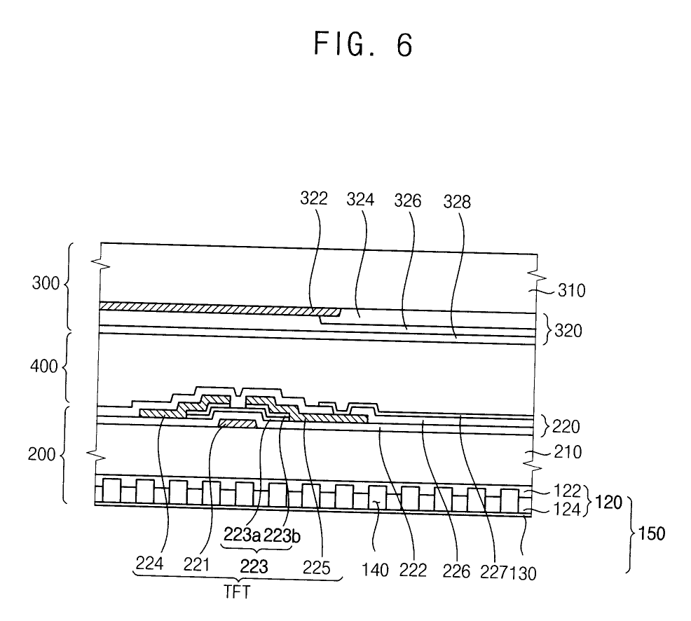

FIG. 6 is a cross-sectional view illustrating an exemplary embodiment of a liquid crystal display (“LCD”) panel including a polarizer according to the present invention

Referring to FIG. 6, the LCD panel according to the illustrated embodiment may include a first (display) substrate 200, a second (opposite) substrate 300 and a liquid crystal layer 400 disposed between the first substrate 200 and the second substrate 300.

The display substrate 200 may include a first base substrate 210, a polarizing part 150 and a first pixel layer 220.

The first base substrate 210 may be a transparent substrate. The first base substrate 210 may include a glass material.

The polarizing part 150 is disposed below the first base substrate 210, and opposite to the first pixel layer 220 with respect to the first base substrate 210. P-polarized light of the light incident into the first base substrate 210 is transmitted by the polarizing part 150, and s-polarized light of the light incident into the first base substrate 210 is reflected by the polarizing part 150. The p-polarized light transmitted by the polarizing part 150 passes completely through the first pixel layer 220 to be incident on the liquid crystal layer 400. The s-polarized light reflected by the polarizing part 150 is re-reflected at the optical sheet of a backlight assembly (not shown) disposed below the LCD panel, to become randomly polarized light incident on the LCD panel. The reflected light of the optical sheet of the backlight assembly, which is the randomly polarized light, is again reflected and polarized by the polarizing part 150.

The polarizing part 150 may include the reflective polarizing layer 120 and the protective layer 130. While the polarizer 101 of FIG. 1 is shown in FIG. 6, the polarizer of FIGS. 3-5 may alternatively be employed in the LCD panel.

Referring to FIG. 6, the reflective polarizing layer 120 is substantially the same or identical to the reflective polarizing layer 120 described with reference to FIG. 1. The reflective polarizing layer 120 is disposed below the first base substrate 210, and opposite to both the LC layer 400 and the first pixel layer 220, with respect to the first base substrate 210. The reflective polarizing layer 120 may include a plurality of a WGP pattern 122 and the metal layer 124.

Each of the WGP patterns 122 has a predetermined width W taken in a horizontal direction of FIG. 6, and thickness T taken in a vertical direction of FIG. 6. The plurality of the WGP pattern 122 is disposed spaced apart from each other at substantially uniform intervals in the horizontal direction. The spacing apart of the WGP patterns 122 defines a gap between adjacent WGP patterns 122.

The WGP patterns 122 may include a first portion having a larger thickness in the vertical direction of FIG. 6, than a thickness of a second portion. The first and second portions of the WGP patterns 122 may be alternated with each other to overlap and contact an entire of the first base substrate 210. The first and second portions of the WGP patterns 122 form a single, continuous and indivisible pattern member, as illustrated in FIG. 6. Each of the second portions of the WGP patterns 122 may be disposed between the gap defined by separated adjacent WGP patterns 122, and the first base substrate 210.

In a plan view, the WGP patterns 122 may have a substantially stripe type, or a striped shape. The WGP patterns 122 may include a material having high reflectivity and low light absorbance. In one exemplary embodiment, the WGP patterns 122 may include acrylic resin.

The metal layer 124 is disposed directly on the WGP patterns 122. The metal layer 124 may include a metal having a relatively high reflectivity such as aluminum (Al), silver (Ag), copper (Cu), gold (Au) and/or molybdenum (Mo). The metal layer 124 is disposed between the WGP patterns 122 and the protective layer 130.

The protective layer 130 is substantially the same or identical to the protective layer 130 described with reference to FIG. 1. The protective layer 130 is disposed directly on and contacting the reflective polarizing layer 120, and protects the reflective polarizing layer 120. In an exemplary embodiment, the protective layer 130 may directly contact a portion of the WGP patterns 122.

The protective layer 130 is spaced apart from a bottom surface of the space between the WGP patterns 122, such as to define an air layer 140 between the WGP patterns 122. The protective layer 130 may include a material having a relatively high transmissivity. The protective layer 130 may include heat-curable materials or UV-curable materials.

Additionally, the protective layer 130 may include a material having adhesive characteristics relative to the metal layer 124 and/or the protective layer 130. In one exemplary embodiment, the protective layer 130 may include acrylic resin, epoxy resin, etc. A thickness of the protective layer 130 may range from approximately a few hundred nm, to approximately tens of thousands of nm.

The first pixel layer 220 may be disposed directly on and contacting the first base substrate 210. The first pixel layer 220 may include a plurality of a unit pixel. Each of the unit pixels of the first pixel layer 220 may include a thin-film transistor (“TFT”) connected to signal lines (not shown), and a pixel electrode 227. The first pixel layer 220 may further include a gate insulation layer 222 and a protective insulation layer 226. The signal lines may include a gate line extended in the first direction, and a data line crossing the gate line and extended in the second direction.

The gate insulation layer 222 is disposed directly on and contacting an upper surface of the first base substrate 210.

The TFT may include a gate electrode 221 connected to the gate line, a source electrode 224 connected to the data line, a drain electrode 225 spaced apart from the source electrode 224, and an active pattern 223. The active pattern 223 may include a semiconductor layer 223a and an ohmic contact layer 223b sequentially disposed on the gate insulation layer 222.

The protective insulation layer 226 is disposed on the first base substrate 210 including the TFT formed thereon.

The pixel electrode 227 is electrically connected to the TFT. The pixel electrode 227 may be disposed on the protective insulation layer 226, and is electrically connected to the drain electrode 225 through a contact hole exposing terminals of the protective insulation layer 226 and the drain electrode 225.

The opposite substrate 300 may include a second base substrate 310 and a second pixel layer 320.

The second base substrate 310 may be a transparent substrate substantially identical to the first base substrate 210.

The second pixel layer 320 is disposed on the second base substrate 310. The second pixel layer 320 may include a plurality of a unit pixel. Each of the unit pixels of the second pixel layer 320 may include a common electrode 326. The second pixel layer 320 may further include a light-blocking pattern 322, a color filter layer 324 and an overcoat layer 328.

The liquid crystal layer 400 is interposed between the display substrate 200 and the opposite substrate 300.

When the polarizer according to an embodiment of the present invention is applied to the LCD panel, the polarizer may be applied in the form of the polarizer 101 according to Embodiment 1 in FIG. 1, and the first base substrate 210 shown in FIG. 6 is used as a base layer 110 of the polarizer 101.

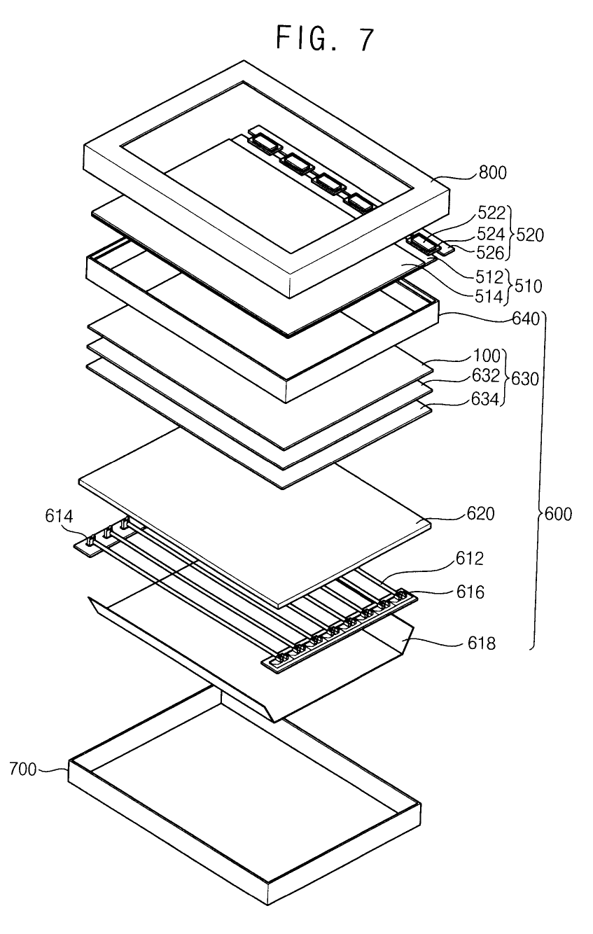

FIG. 7 is an exploded perspective view illustrating an exemplary embodiment of an LCD device including a backlight assembly including a polarizer according to the present invention.

Referring to FIG. 7, the LCD device may include a display panel 510, a panel driving part 520, a backlight assembly 600, a bottom chassis 700 and a top chassis 800.

The display panel 510 displays images using light provided from the backlight assembly 600 and/or light externally provided to the LCD panel. The display panel 510 may include a display substrate 512, an opposite substrate 514 opposite to the display substrate 512, and a liquid crystal layer (not shown) interposed between the display substrate 512 and the opposite substrate 514.

The panel driving part 520 drives the display panel 510. The panel driving part 520 may include a driving chip 522 mounted on a signal transmission substrate 524, and a driving circuit substrate 526 electrically connected to the driving chip 522. An uppermost side of the LCD device illustrated in FIG. 7, may hereinafter be referred to as a “viewing side,” and a lowermost side of the LCD device illustrated in FIG. 7 may hereinafter be referred to as a “rear side.”

The backlight assembly 600 is disposed below the display panel 510, and provides light to the display panel 510. The backlight assembly 600 may include a light source (e.g., lamp) 612, a light source holder (e.g., lamp socket) 614, a ground member (e.g., socket) 616, a reflecting member (e.g., reflector) 618, a planar diffusing member (e.g., diffusion plate) 620, an optical member (e.g., sheet) 630 and a mold frame 640.

The lamp 612 generates the light. The lamp socket 614 is disposed at a first terminal of the lamp 612 to fix the lamp 612, and the lamp socket 614 supplies power to the lamp 612.

The ground socket 616 is disposed at a second terminal of the lamp 612, opposing the first terminal, to fix the lamp 612, and to ground the lamp 612.

The reflector 618 is disposed below the lamp 612, and opposite to the display panel 510 relative to the lamp 612. The light emitted from the lamp 612 and towards the reflector 618 is reflected by the reflector to an upper side of the lamp 612 towards the viewing side of the LCD device. The reflector 618 may include a material having high reflectivity.

The diffusion plate 620 is disposed above the lamp 612, on a viewing side of the lamp 612. The diffusion plate 620 diffuses the light generated from the lamp 612 to improve luminance uniformity.

The optical sheet 630 is disposed on the diffusion plate 620, between the diffusion plate 610 and the display panel 510, and condenses and diffuses the light exiting from the diffusion plate 620. In an exemplary embodiment, the optical sheet 630 may include a diffusion sheet 634, a prism sheet 632 and a reflective polarizing sheet 100.

The diffusion sheet 634 improves the luminance and luminance uniformity of the light incident on the optical sheet 630 from the diffusion plate 620.

The prism sheet 632 is disposed on the diffusion sheet 634, and between the reflective polarizing sheet 100 and the diffusion sheet 634. The prism sheet 632 may include a plurality of a prism pattern (not shown) condensing light diffused by the diffusion sheet 634.

The reflective polarizing sheet 100 is disposed on the prism sheet 632, and between the display panel 510 and the prism sheet 632. The reflective polarizing sheet 100 reflects and polarizes light incident into the reflective polarizing sheet 100 from the prism sheet 632. The reflective polarizing sheet 100 may include at least one form of the polarizer according to Embodiment 1 to Embodiment 4 in FIGS. 1, 3, 4 and 5. In an exemplary embodiment, the base layer of the polarizer may have a film shape, such as being substantially planar defined by the first and second directions, while being relatively thin in the third direction.

The reflective polarizing sheet 100 may include the base layer 110, the reflective polarizing layer 120 and the protective layer 130 in substantially the same way as the polarizer 101 in FIG. 1. The protective layer 130 may include the optical pattern 134 in substantially the same way as the polarizer 102 in FIG. 3. In an exemplary embodiment, when the reflective polarizing sheet 100 includes the protective layer 130 including the optical pattern 134, the prism sheet 632 may be omitted.

The reflective polarizing sheet 100 may include the lower base layer 110, the reflective polarizing layer 120, the protective layer 130 and the upper base layer 115 in substantially the same way as the polarizer 103 in FIG. 4. In addition, the reflective polarizing sheet 100 may include the lower base layer 110, the reflective polarizing layer 120, the protective layer 130, the upper base layer 115 and the optical pattern 134 in substantially the same way as the polarizer 104 in FIG. 5. In an exemplary embodiment, when the reflective polarizing sheet 100 includes the optical pattern 134 described with reference to FIG. 5, the prism sheet 632 may be omitted.

The mold frame 640 is disposed below the display panel 510, and supports the display panel 510. The mold frame 640 may contact peripheral edges of a lower surface of the display panel 5 10.

The bottom chassis 700 is disposed below the backlight assembly 600, at a rear side of the LCD device, and receives the backlight assembly 600. The bottom chassis 700 may include a bottom portion and sidewalls extending from edges of the bottom portion toward a viewing side of the LCD device. The bottom portion of the bottom chassis 700 may be a solid and continuous member, or alternatively may include openings.

The top chassis 800 is disposed on the display panel 510, and is combined with the bottom chassis 700. The top chassis 800 may include a top portion and sidewalls extending from edges of the top portion toward the rear side of the LCD device. The top chassis 800 may be configured to reduce or effectively prevent damage to the display panel 510 and/or the backlight assembly 600 from external impacts. A window defined by the top portion of the top chassis 800 is disposed in the top chassis 800, and exposes a display area of the display panel 510 to the viewing side of the LCD device.

According to the illustrated embodiment, when the polarizer is manufactured in the form of an optical sheet to be disposed in the backlight assembly 600, the conventional polarizer member disposed below the display panel to improve polarizing function, may be omitted.

When the polarizer according to an exemplary embodiment of the present invention is disposed below the display panel 510, the dual brightness enhancement film (DBEF) optical sheet in the backlight assembly 600 may be omitted.

According to exemplary embodiments of the present invention, a WGP pattern may be relative easily formed to enable the production of relatively large LCD devices, and a relatively large amount of the LCD devices. When the protective layer is formed on the WGP pattern, an air layer is defined between the WGP patterns to advantageously improve optical efficiency. In addition, when a polarizer is applied to a display device, the efficiency of light generated from a light source may be improved so that a polarizing plate adhered to a DBEF optical sheet or a display panel may be omitted.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims.

In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A polarizer comprising:
a first base layer;
a reflective polarizing layer disposed on the first base layer, and comprising a plurality of a wire-grid polarizer pattern spaced apart from each other at substantially uniform intervals; and
a protective layer disposed on the reflective polarizing layer, and opposite to the first base layer with respect to the reflective polarizing layer, the protective layer contacting the reflective polarizing layer and forming an air layer between adjacent wire-grid polarizer patterns, the protective layer and the first base layer.

2. The polarizer of claim 1, wherein the reflective polarizing layer further comprises a metal layer disposed on the wire-grid polarizer patterns, and between the wire-grid polarizer patterns and the protective layer.

3. The polarizer of claim 1, wherein the protective layer comprises an optical pattern condensing and diffusing light transmitted through the reflective polarizing layer.

4. The polarizer of claim 3, wherein the protective layer is adhesive with respect to the base layer.

5. The polarizer of claim 1, further comprising:
a second base layer disposed on the protective layer, and opposite to the first base layer with respect to the protective layer, the second base layer having a first thickness substantially the same as a second thickness of the first base layer, the first and second thicknesses taken substantially perpendicular to the first base layer.

6. The polarizer of claim 5, further comprising:
an optical pattern disposed on the second base layer, and opposing the first base layer with respect to the second base layer, the optical pattern condensing and diffusing light transmitted through the second base layer.

7. A method of manufacturing a polarizer, the method comprising:
forming a reflective polarizing layer including a plurality of a wire-grid polarizer pattern disposed on a first base layer and spaced apart from each other at substantially uniform intervals; and
forming a protective layer disposed on the reflective polarizing layer and opposite to the first base layer with respect to the reflective polarizing layer, the protective layer contacting the reflective polarizing layer and forming an air layer between adjacent wire-grid polarizer patterns, the protective layer and the first base layer.

8. The method of claim 7, wherein the forming a reflective polarizing layer further comprises:
forming a metal layer disposed on the wire-grid polarizer patterns, and between the protective layer and the wire-grid polarizer patterns.

9. The method of claim 7, wherein the forming a reflective polarizing layer comprises:
forming a coating layer directly on the first base layer;
forming the wire-grid polarizer patterns pattern by pressing the coating layer using a mold in which a pattern of the wire-grid polarizer patterns is formed;
curing the coating layer including the patterned coating layer formed thereon; and
removing the mold from the patterned coating layer.

10. The method of claim 7, wherein the protective layer comprises an optical pattern condensing and diffusing light transmitted through the reflective polarizing layer.

11. The method of claim 7, further comprising:
forming a second base layer disposed on the protective layer and opposite to the first base layer with respect to the protective layer, the second base layer having a thickness substantially identical to a thickness of the first base layer.

12. The method of claim 11, further comprising:
forming an optical pattern disposed on the second base layer, the optical pattern condensing and diffusing light transmitted through the second base layer.

13. A display substrate comprising:
a base substrate;
a pixel layer disposed on the base substrate, and including a plurality of a pixel unit; and
a polarizing part disposed on the base substrate opposing the pixel layer with respect to the base substrate, the polarizing part comprising:
a reflective polarizing layer comprising a plurality of a wire-grid polarizer pattern spaced apart from each other at substantially uniform intervals; and
a protective layer disposed on the reflective polarizing layer and opposing the base substrate with respect to the reflective polarizing layer, the protective layer contacting the reflective polarizing layer,
wherein the protective layer, the base substrate and adjacent wire-grid polarizer patterns define an air layer therebetween.

14. The display substrate of claim 13, wherein the reflective polarizing layer further comprises a metal layer disposed on the wire-grid polarizer patterns and between the wire-grid polarizer patterns and the protective layer.

15. The display substrate of claim 13, wherein the protective layer comprises an optical pattern condensing and diffusing the light transmitted through the reflective polarizing layer.

16. A backlight assembly comprising:
a light source; and
a reflective polarizer adjacent to the light source, the reflective polarizer comprising:
a reflective polarizing layer disposed on the first base layer and comprising a plurality of a wire-grid polarizer pattern spaced apart from each other at substantially uniform intervals; and
a protective layer contacting the reflective polarizing layer and defining an air layer between the wire-grid polarizer patterns, the first base layer and the protective layer.

17. The backlight assembly of claim 16, wherein the reflective polarizing layer further comprises a metal layer disposed on the wire-grid polarizer patterns and between the protective layer and the wire-grid polarizer patterns.

18. The backlight assembly of claim 16, wherein the protective layer comprises an optical pattern condensing and diffusing light transmitted through the reflective polarizing layer.

19. The backlight assembly of claim 16, further comprising:
a second base layer disposed on the protective layer and opposing the first base layer with respect to the reflective polarizing layer, the second base layer having a thickness substantially identical to a thickness of the first base layer.

20. The backlight assembly of claim 19, further comprising:
an optical pattern disposed on the second base layer, the optical pattern condensing and diffusing light transmitted through the second base layer.
